(19) United States
(12) Patent Application Publication
(10) Pub. No.: US 2026/0041078 A1
(43) Pub. Date: Feb. 12, 2026

(54) HORSE SHOE

(71) Applicant: EasyCare, Inc., Durango, CO (US)

(72) Inventor: Garrett Ford, Durango, CO (US)

(73) Assignee: EasyCare, Inc., Durango, CO (US)

(21) Appl. No.: 19/294,025

(22) Filed: Aug. 7, 2025

Related U.S. Application Data
(60) Provisional application No. 63/680,473, filed on Aug. 7, 2024.

(51) Int. Cl. A01L 5/00

(52) U.S. Cl. CPC A01L 5/00

(57) ABSTRACT

A polymer horse shoe attachable to a horse hoof with adhesive and or nails. The shoe includes removable cuffs and an embedded plate with protruding tabs.

### CROSS-REFERENCE TO RELATED APPLICATION(S)

This patent application claims priority to U.S. Provisional Patent Application No. 63/680,473, titled “Improved Horse Shoe” and filed Aug. 7, 2024, the disclosure of which is incorporated herein by reference to the extent it does not conflict with the present disclosure.

### FIELD OF THE INVENTION

This patent application relates to horse shoes.

### BACKGROUND

In recent decades, the equine industry developed a number of polymeric, horse shoes that are bonded to the hoof. For example, U.S. Pat. No. 4,892,150 (Thoman) describes a polymeric, hoof-bonded bonded horse shoe. As disclosed in Thoman, a polymeric horseshoe is attached to a shoe structure with upward extending tabs that are bonded to the hoof.

While the existing polymeric horse shoe provide advantages over traditional horseshoe designs, they suffer from a number of persistent and performance-limiting drawbacks. For example, referring to Thoman, extended tests on a similar boot (i.e., a glued-on boot with an open bottom and a polymeric horseshoe integral with an upper that conforms to the hoof) demonstrated that the boot quickly begins to show signs of loosening from the rear portion of the hoof and eventually it becomes totally separated. It appears that the deformation of the hoof caused by the enlargement of the frog and the quarters of the hoof at each step produces a strain on its bond with the boot. As the hoof increases in size (in width) on impact with the ground, the horseshoe portion of the boot, having an open back side at the heel, is forced to increase its width against its normal shape and the resulting strain eventually produces a breakdown in the bond and the detachment of the horse shoe. Over the years, numerous attempts to correct this problem with different placements of glue and with different retaining structures have failed to fully resolve detachment issues.

In another example, U.S. Pub. No. US 20140231101 (Ford) disclosed an improved horse shoe with lateral cuffs having lateral holes for receiving thick, polyurethane glues to adhere the shoes to horse hooves. The Ford disclosure provided for the bonding of a cuff (or side walls) directly to the hoof. In particular, the cuffs of Ford had lateral holes or perforations to allow excess glue to ooze out during the fitting process and bind to the perforations and portions of the exterior wall. Ford further taught the necessity of an appropriate thickness of glue for securing the horse shoe to the hoof is a glue layer between 1.5 and 3 mm in thickness, excluding the thickness of the recesses and notches. The use of polyurethane, urethane and acrylic glues that achieved such thicknesses and adhesion, while functional, are highly costly and messy to use, thus resulting at times in wasted material or unaesthetic finished products.

What is needed, therefore, is a horse shoe that resolves or improves upon one or more of the preceding drawbacks.

### SUMMARY

This application discloses a horse shoe with a cuff(s), a sole, a plate embedded in the sole, and a tab(s) protruding from the sole. The cuff(s) are removable, thus creating multiple distinct attachment configurations of the horse shoe.

### BRIEF DESCRIPTION OF DRAWINGS

Embodiments of the application will be described in detail in conjunction with FIGS. 1-8.

FIG. 1 is a perspective side view of a horse shoe according to the disclosure.

FIG. 2 is a side view of a horse shoe according to the disclosure.

FIG. 3 is a perspective rear view of a horse shoe according to the disclosure.

FIG. 4 is a perspective rear view of a horse shoe according to the disclosure.

FIG. 5 is a top view of a horse shoe according to the disclosure.

FIG. 6 is a perspective rear view of a horse shoe with an embedded plate according to the disclosure.

FIG. 7 is a top view of a horse shoe having an embedded plate according to the disclosure.

FIG. 8 is a bottom view of a horse shoe having an embedded plate according to the disclosure.

### DETAILED DESCRIPTION

Other features and advantages of this disclosure will become apparent in the following detailed description of the embodiment(s) with reference to the accompanying drawings.

To aid in describing the disclosure, directional terms may be used in the specification and claims to describe portions of the present disclosure (e.g., front, rear, left, right, top, bottom, proximal, distal, superior, inferior, etc.). These directional definitions are intended to merely assist in describing and claiming the disclosure and are not intended to limit the disclosure in any way.

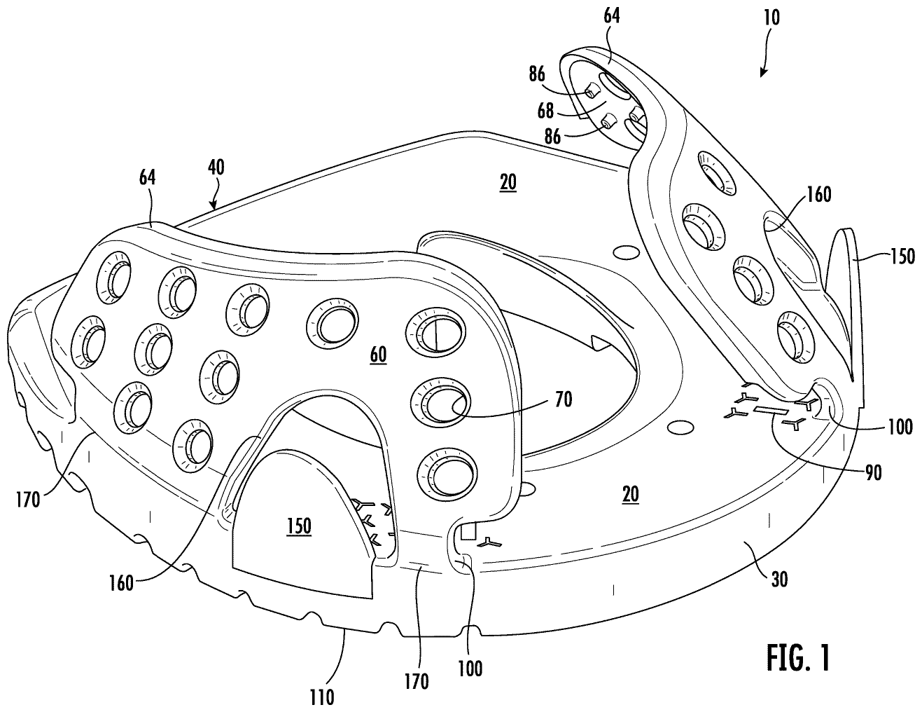

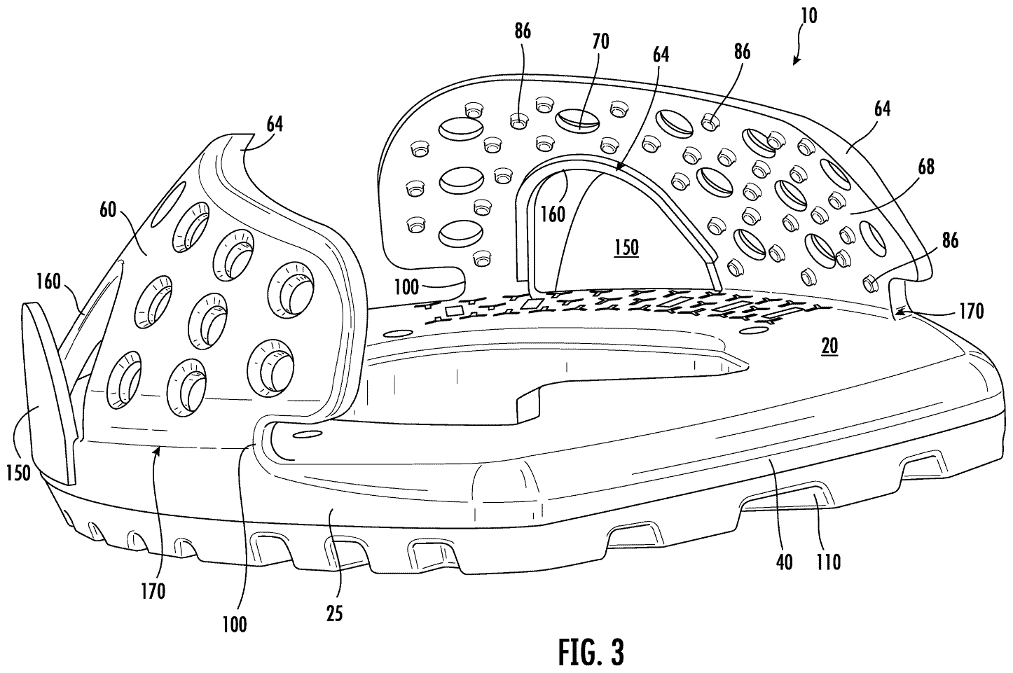

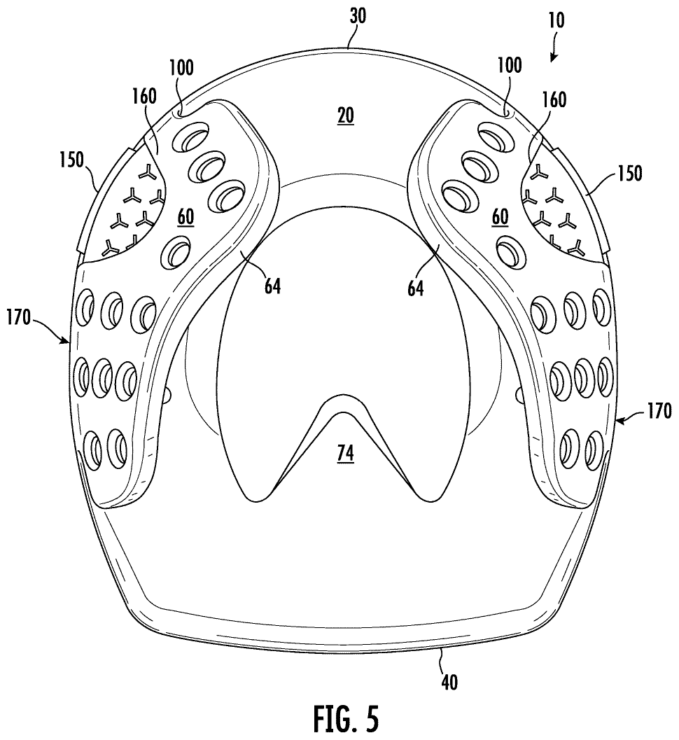

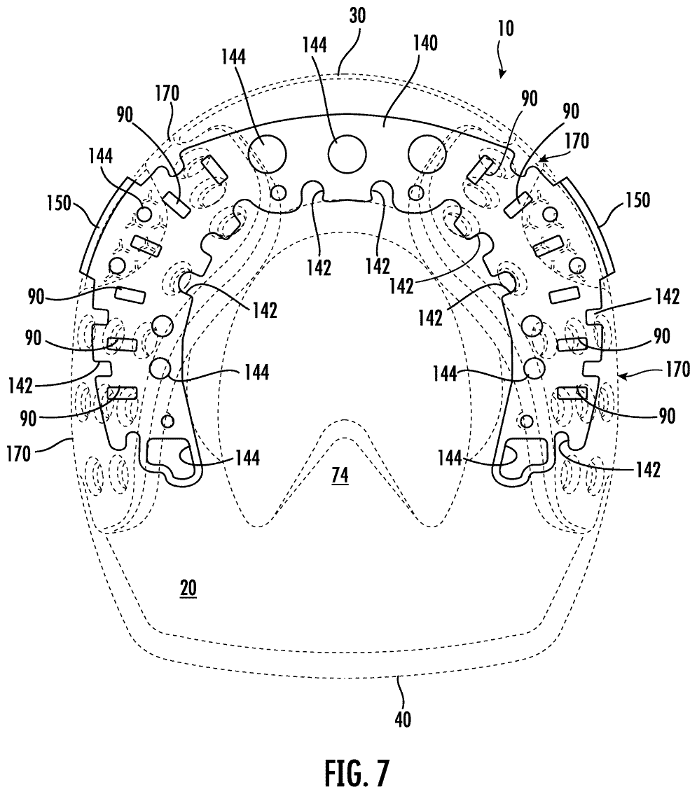

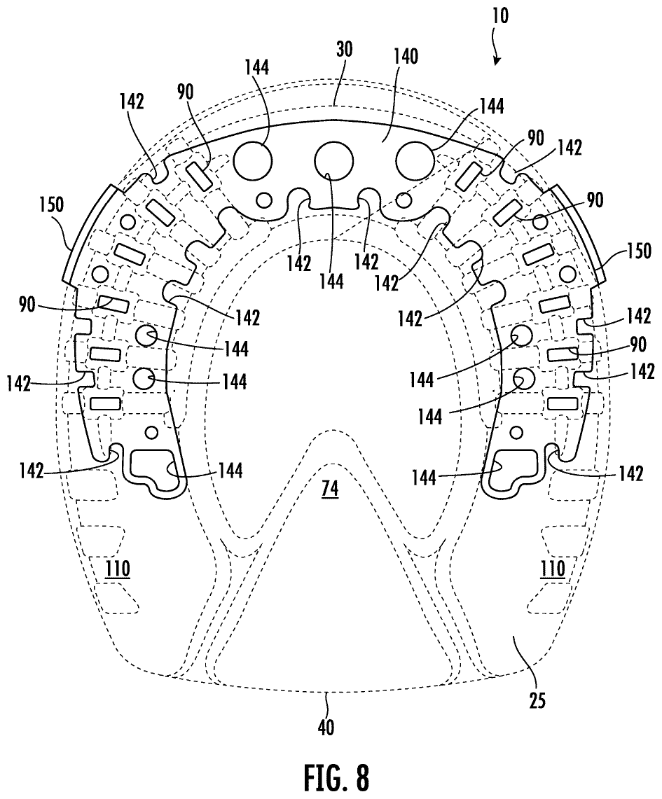

Embodiments of the present disclosure are best understood by referring to FIGS. 1-8 of the drawings, like numerals being used for like and corresponding parts of the various drawings.

### LIST OF REFERENCES

10 Horse Shoe
20 Horse Sole Bed
25 Sole
30 Distal End
40 Proximal End
60 Lateral Wall or Cuff
64 Rim
68 Interior Space
70 Hole
74 Frog Support
82 Perimeter
86 Pin
90 Fenestration
100 Carveout
110 Treads
120 Superior Region
130 Inferior Region
140 Plate
142 Groove
144 Hole
150 Tab
160 Cuff Aperture
170 Removal Region

As used herein, the term “horse shoe” is used to describe a lower profile, wearable hoof protecting item, without a gaiter, that may wrap only partially around the hoof of the horse. The term “sole” is defined to refer that part of a horse shoe that covers the underside of the hoof By contrast, the term “horseshoe” is defined to refer to a structure, made of any material, that is substantially in the form of a conventional iron horseshoe that has an open heel and an interior open area corresponding substantially to the interior underside of the hoof of the horse. As described with reference to the present disclosure, the heel portions of the heel are connected by a bridging structure.

Referring generally to the drawings, FIGS. 1-8 disclose a horse shoe 10 having a sole, a frog support 74, optionally removable lateral walls or cuffs 60 that correspond with horse hoof anatomy, and an embedded plate 140 with deformable tabs 150. Cuffs 60 are provided with holes 70 to receive adhesive, and apertures 160, through which tabs 150 can be deformed. The embedded plate 140 provides rigid support, and the deformable tabs provide a close-fitting connection with the hoof when in use, thereby limiting the hoof from excessive distal sliding in shoe 10. Embedded plate 140 is provided with a plurality of grooves 142, as well as holes 144, to improve retention of plate 140 in sole 25.

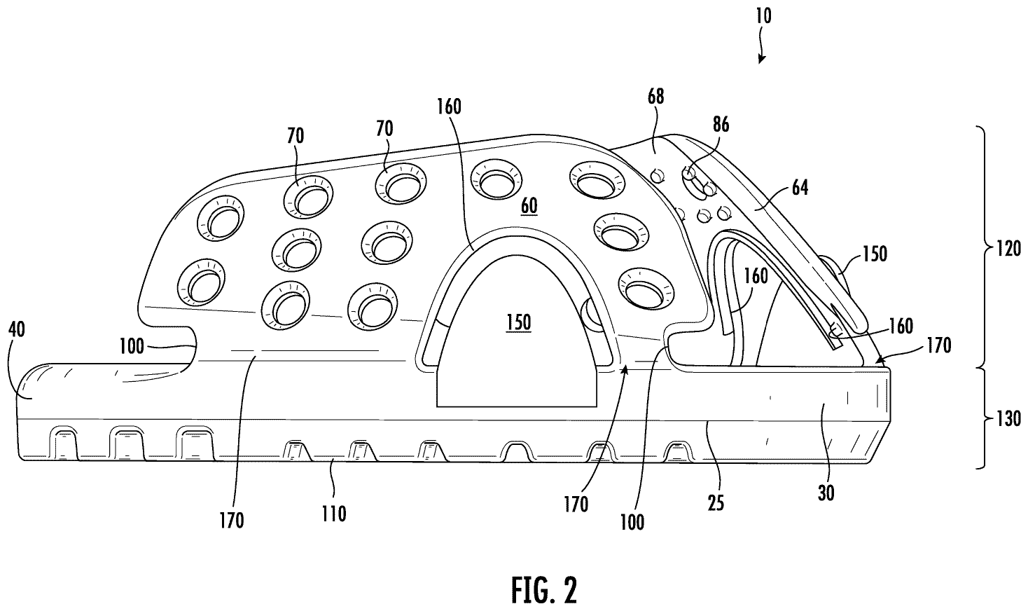

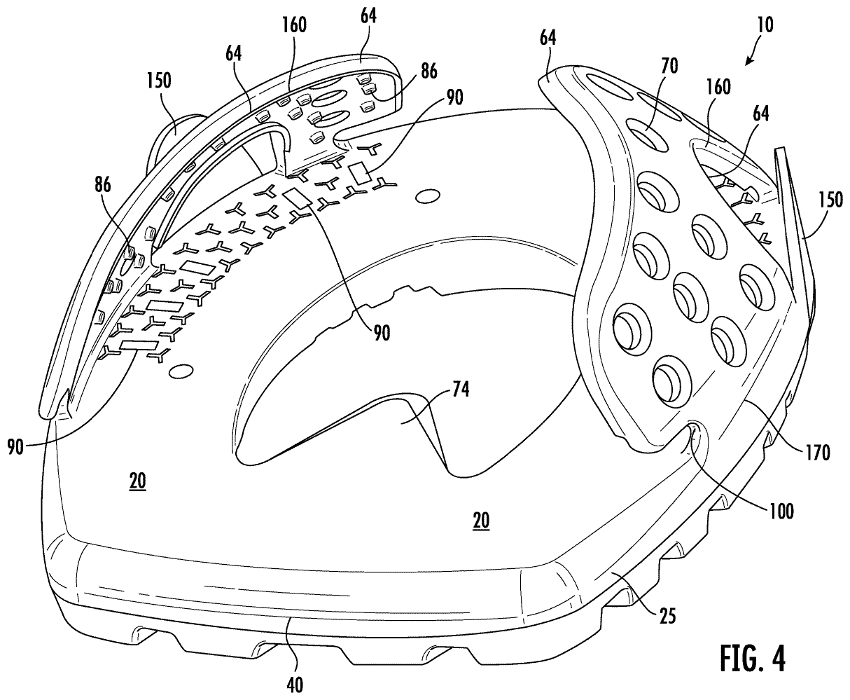

As best shown in FIGS. 2, horse shoe 10 includes a superior region 120 and an inferior region 130 between a distal end 30 and a proximal end 40. Superior region 120 includes curved lateral walls or cuffs 60 that extend in a superior direction from sole bed 20. As shown in FIGS. 1, 4 and 6, the borders of cuffs 60 include an interior facing lip or rim 64 that defines an interior space 68 between the horse hoof and cuff 60 when in use. Cuff 60 further includes holes 70 and a number of interior pins 86, which provide structure and support between cuff 60 and the horse hoof. In addition, as shown in FIG. 2, inferior region 130 includes a lower horse sole bed 20, sole 25 and treads 110, which provide for improved traction. Sole 25 can be provided with nail fenestrations 90 (FIG. 4), which permit nailing horse shoe 10 to a horse hoof. In one preferred embodiment, the horse shoe is formed from a polymer having a durometer between 80A and 90A.

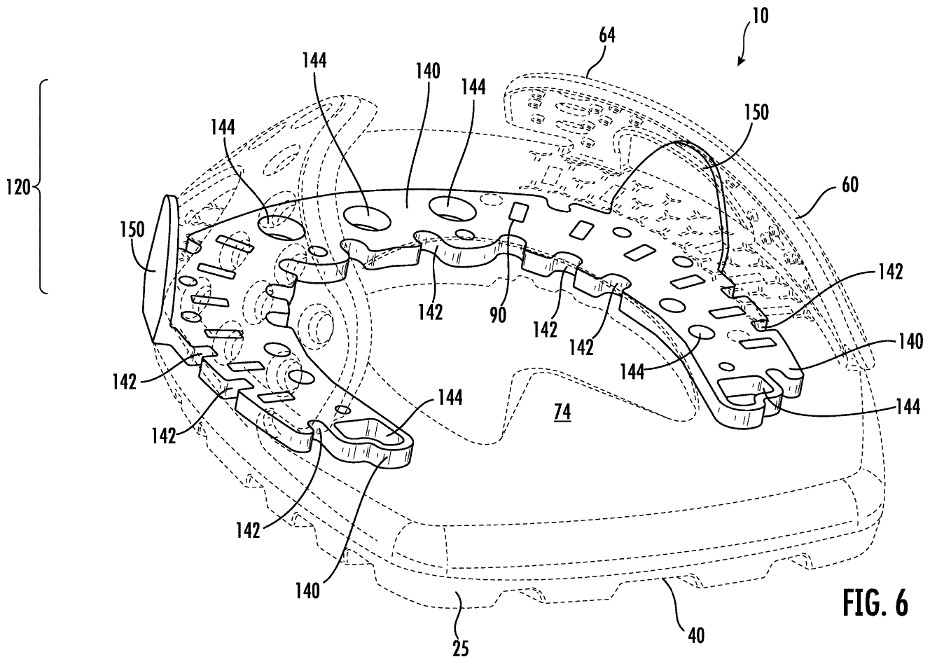

Referring to FIGS. 6-8, horse shoe 10 includes a plate 140 having tab(s) 150. Plate 140 is preferably made of a metal or other material having a high rigidity or hardness. As shown in FIG. 6, plate 140 is embedded in the midsole region of the sole 25. Tabs 150 of plate 140 extend from the midsole into the superior region 120. Preferably, tabs 150 are selectively deformable during sizing and attachment of the horse shoe, as detailed below. That is, tabs 150 can be deformed or bent toward the hoof wall or toe, thus securely restricting the hoof from sliding beyond distal end 30. Referring to FIGS. 1-2, apertures 160 are provided to allow tabs 150 to be deformed to directly and closely contact the hoof wall or toe. Such tabs therefore prevent the hoof from slipping or sliding distally relative to horse shoe 10.

Cuffs 60 are removable from horse shoe 10 at removal regions 170. As shown in FIGS. 1-8, cuffs 60 are preferably connected to the horse shoe in a region extending generally along line 170 (see FIG. 1). Preferably, the removal region 170 is approximately 2 mm in thickness to facilitate cutting, although a thickness between 1 millimeter and 4 millimeters is acceptable. The removal region 170 permits a user to altogether dispense with cuffs 60 and a glue-based adhesion of the horse shoe to the horse hoof. That is, before attachment of the horse shoe 10 to the hoof, a user can slice off the cuffs at the removal region 170 with a blade, scissors or other cutting tool, discard the cuffs, and attach only the remaining inferior portion 130 of the horse shoe 10 and tabs 150. In another alternative embodiment, a region along line 170 can be provided in a frangible configuration that facilitates removal of the cuffs. By removing the cuffs, a user can attach horse shoe 10 to a horse hoof with horseshoe nails inserted through fenestrations 90 and into the horse hoof, as well as deforming tabs 150 to correspond with the angle of the horse hoof wall. In addition, carveouts 100 are provided to accommodate growth of the hoof without detaching the horse shoe from the hoof.

In one embodiment, cuffs 60 can be provided with an interior space 68 defined by rim 64. In such an embodiment, cuffs 60 are configured to receive thick polyurethane glues, which are pressed out of holes 70 during the adhesion process. In an alternative embodiment, horse shoe 10 can be optionally used with an interior liner, as described in U.S. application Ser. No. 19/221,105, which is incorporated by reference herein in its entirety. The liner can be snap-fit, press-fit or torsion-fit within rim 64. Further, the liner includes a number of pegs that snap-fit into holes 70, and a plurality of dimples, holes or recesses that correspond with and accommodate interior pins 86. In use, therefore, a cyanoacrylate style adhesive is applied to the liner, and it is then popped or snapped into interior space 68, with the pegs being secured in holes 70.

The resulting horse shoe 10 is highly flexible in terms of its manner of attachment to a hoof. In particular, a user can attach horse shoe 10 using any of at least three different configurations. In a first configuration, the cuffs are left on the horse shoe and the horse shoe can be attached directly to the hoof with thick polyurethane adhesive. In a second configuration, a cyanoacrylate-style adhesives can be used in connection with a liner. In the first and second configurations, the horse shoe can be further secured to the hoof with conventional horseshoe nails inserted through fenestrations 90. In the third configuration, cuffs 60 are removed altogether and the horse shoe 10 is mechanically attached to the horse hoof with nails and further secured by tabs 150.

To fit the horse shoes 10 to a particular horse, a user must first size each hoof. Specifically, to fit the horse shoe 10 of FIGS. 1-8, a user must first size each hoof. This can be accomplished by measuring the width and length of each hoof with a fit-kit, such as supplied by Easycare, Inc. Based on the width and length of each hoof, a horse shoe 10 of a proper size is selected, and each hoof is prepared for fitting the horse shoe. Depending on the preference of the user, the horse shoe can be attached using either adhesive, adhesive and nails, or only nails.

When using adhesive, the hoof is first prepared by buffing the surface of the hoof wall with a hoof buffer, removing excess moisture with a torch or other conventional means, and brushing the hoof wall. To attach the horse shoe 10 with a thick polyurethane adhesive, the horse shoe is press fit onto the hoof. Polyurethane is then dispensed into each hole 70 of the cuffs so as to fill interior space 68. A bead of polyurethane can also be applied where the hoof toe meets the horse sole bed, as well as along the perimeter 82 of the cuff. Excess polyurethane on the outside of the cuff is then smoothed and wiped away. A cellophane sheet can be used to temporarily secure the horse shoe to the horse hoof during curing/drying of the polyurethane adhesive. Once dry, it can be removed and the hoof can be buffed to remove any excess adhesive. A thin coat of cyanoacrylate adhesive can be spread on the exterior of the cuffs and exposed hoof wall to further seal the horse shoe. Depending on the preference of the user, the horse shoe can then be nailed to the horse hoof using traditional farrier methods. That is, in addition to polyurethane adhesive, the user can also nail horseshoe nails through fenestrations 90 and into the hoof.

In an alternative form of attachment, if a cyanoacrylate or other instant but thin adhesive is to be used instead of a thick polyurethane glue, a liner is glued into the interior space 68 of the cuffs. The hoof is preferably prepared as described above. Cyanoacrylate adhesive is then applied to the exposed portion of the liner and the hoof wall. Before the adhesive cures, the assembled horse shoe is pressed onto the prepared hoof. A cellophane sheet can be used to temporarily secure the horse shoe to the horse hoof during curing/drying of the glue. The horse shoe can then be nailed to the horse hoof using traditional farrier methods.

In the event the user only wants to use nails, the user can cut the cuffs off with a blade and position the horse shoe on the hoof. With the shoe positioned, the farrier can deform the tabs to closely fit the angle and shape of the hoof wall. This may require repeatedly adjusting the tab to ensure a close fit. Once a close fit is achieved, horseshoe nails are inserted through the fenestrations 90 and nailed to the hoof.

This disclosure describes various elements, features, aspects, and advantages of various embodiments and examples and configurations thereof of composite compositions. It is to be understood that certain descriptions of the various embodiments have been simplified to illustrate only those elements, features and aspects that are relevant to a more clear understanding of the disclosed embodiments, while eliminating, for purposes of brevity or clarity, other elements, features and aspects. Any references to “various embodiments,” “certain embodiments,” “some embodiments,” “one example,” “one embodiment,” “an example,” or “an embodiment” generally means that a particular element, feature and/or aspect described in the embodiment is included in at least one embodiment. The phrases “in various embodiments,” “in certain embodiments,” “in some embodiments,” “in one embodiment,” or “in an embodiment” may not refer to the same embodiment.” Furthermore, the phrases “in one such embodiment” or “in certain such embodiments,” or “in one example,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. As such, it is to be understood that the description set forth herein is merely exemplary and illustrative of the disclosed embodiments and is not intended to limit the scope of the invention as defined solely by the claims.

1. A horse shoe comprising:
a sole;
a plate embedded in the sole;
a tab extending from the plate and protruding from the sole; and
a first cuff extending from the sole, the cuff having a plurality of openings and an aperture,
and a rim defining an interior space;
wherein the tab extends into the aperture.

2. The horse shoe of claim 1, further comprising:
a second tab extending from the plate and protruding from the sole; and
a second cuff extending from the sole, the second cuff having a plurality of openings and an aperture, and a rim defining an interior space;
wherein the second tab extends into the second cuff aperture.

3. The horse shoe of claim 2, wherein the sole, first cuff and second cuff are formed from a polymer having a durometer between 80A and 90A.

4. The horse shoe of claim 3, wherein the first cuff and the second cuff each comprise a removal region having a thickness of approximately 2 millimeters.

5. The horse shoe of claim 3, wherein the first cuff and the second cuff each comprise a frangible removal region.

6. The horse shoe of claim 3, wherein the plate, first tab and second tab are metal.

7. The horse shoe of claim 3, wherein the first tab and second tab are deformable.

8. The horse shoe of claim 3, further comprising a plurality of pins extending from the first cuff, and a plurality of pins extending from the second cuff.

9. The horse shoe of claim 3, wherein the sole and the plate have a plurality of fenestrations.

10. A horse shoe comprising:
a sole;
a first cuff extending from the sole, the first cuff defining a first perimeter;
an aperture and a plurality of openings, each of the aperture and plurality of openings extending through the first cuff;
a first rim disposed along the first perimeter of the first cuff, the first rim defining a first interior space;
a second cuff extending from the sole, the second cuff defining a second perimeter;
a second aperture and a second plurality of openings, each of the second aperture and second plurality of openings extending through the second cuff;
a second rim, the second rim extending from the second perimeter, the second rim defining a second interior space;
a metal plate embedded in the sole, the metal plate having:
a first tab, the first tab protruding from the sole, the first tab being sized to fit within the aperture of the first cuff; and
a second tab, the second tab protruding from the sole, the second tab being sized to fit within the aperture of the first cuff;
wherein the sole and the plate have a plurality of fenestrations.

11. The horse shoe of claim 10, wherein the sole is formed from a polymer.

12. The horse shoe of claim 11, wherein the polymer has a durometer between 80A and 90A.

13. The horse shoe of claim 12, wherein the first cuff and second cuff are formed from a polymer.

14. The horse shoe of claim 13, wherein the polymer of the first cuff and second cuff have a durometer between 80A and 90A.

15. The horse shoe of claim 10, further comprising:
a plurality of pins extending from the first cuff; and
a plurality of pins extending from the second cuff.

16. The horse shoe of claim 15, further comprising:
a first removal region in the first cuff; and
a second removal region in the second cuff, wherein the first and second removal regions have a thickness between 1 millimeter and 3 millimeters.

17. The horse shoe of claim 16, wherein each removal region has a thickness of 2 millimeters.

18. The horse shoe of claim 16, wherein each removal region is frangible.

19. A horse shoe comprising:
a sole;
a first cuff extending from the sole, the first cuff having a removal region with a thickness of 2 millimeters, the first cuff defining a first perimeter;
an first aperture and a first plurality of openings, each of the first aperture and first plurality of openings extending through the first cuff;
a first rim disposed along the first perimeter of the first cuff, the first rim defining a first interior space;
a second cuff extending from the sole, the second cuff having a removal region with a thickness of 2 millimeters, the second cuff defining a second perimeter;
a second aperture and a second plurality of openings, each of the second aperture and second plurality of openings extending through the second cuff, a second rim, the second rim extending from the second perimeter, the second rim defining a second interior space;
a metal plate embedded in the sole, the metal plate having:
a first deformable tab, the first deformable tab protruding from the sole, the first tab being sized to fit within the aperture of the first cuff, and
a second deformable tab, the second deformable tab protruding from the sole, the second tab being sized to fit within the aperture of the first cuff,
wherein the sole, first cuff and second cuff are formed from a polymer having a durometer between 80A and 90A.
